(19) United States
(12) Patent Application Publication
(10) Pub. No.: US 2002/0128075 A1
(43) Pub. Date: Sep. 12, 2002

(54) Flexible plate for transmitting torque

(76) Inventor: Craig Stephen Ross, Ypsilanti, MI (US)

Correspondence Address: LAURA C. HARGITT, General Motors Corporation, Mail Code 482-C23-B21, P.O. Box 300, Detroit, MI, 48265-3000, US

(21) Appl. No.: 09/801,326

(22) Filed: Mar. 8, 2001

(51) Int. Cl. F16D 3/52; F16D 3/64; F16D 3/76

(52) U.S. Cl. 464/98

(57) ABSTRACT

A flex plate for transferring torque from a driving component to a driven component comprises an inner hub portion secured for rotation with one of the driving component and the driven component, an outer hub portion secured for rotation with the other one of the driving component and the driven component, and a ring portion extending from the inner hub to the outer hub. The ring portion is a plate having one or more concentric rows of slots formed therethrough, and wherein the slots are circumferential and equiangularly spaced.

### TECHNICAL FIELD

The present invention relates to a flex plate drive connection between an engine crankshaft and a torque converter.

### BACKGROUND OF THE INVENTION

As a powertrain transmits torque between axially adjacent components, it is desirable to allow for some axial compliance therebetween. The interface between the engine and the torque converter is one example. This may be accomplished through the use of certain spline configurations such as involute splines and ball splines. Such spline configurations require several parts and occupy valuable packaging space. A more desirable solution is to employ flexible disks, commonly referred to as “flex plates”. The plate is bolted at an inner hub to one end of the engine crankshaft and around the outer ring to the front cover of the torque converter. A flex plate is stiff in the direction of rotation, permitting torque to be transmitted therethrough, while being compliant due to flexure in the axial direction.

The compliance of the flex plate may be accomplished by cutting relief holes in the material. This strategy must be balanced with the increase in stress levels due to reduced material, particularly at the inner hub and outer bolted joints, and with the decrease in rotational stiffness of the plate.

### SUMMARY OF THE INVENTION

The present invention is for a flex plate providing stiffness in the rotational direction for efficient torque transfer, while permitting axial compliance between adjacent components.

The flex plate for transferring torque from a driving component to a driven component comprises an inner hub portion secured for rotation with one of the driving component and the driven component, an outer hub portion secured for rotation with the other one of the driving component and the driven component, and a ring portion extending from the inner hub to the outer hub. The inner hub has a plurality of equiangularly spaced inner openings and the outer hub has equiangularly spaced outer openings for fastening the flex plate to the driving and driven components.

The ring portion is a flat plate having one or more concentric rows of slots formed therethrough, and wherein the slots are circumferential and equiangularly spaced. The slots in adjacent concentric rows are arranged in a staggered manner. The ring portion further comprises spokes extending radially from the inner hub openings to the outer hub openings and wherein each of the spokes is interrupted by only one of the slots.

This configuration of slots provides a flex plate which is compliant in the axial direction and stiff in the radial direction for torque transmission.

### BRIEF DESCRIPTION OF THE DRAWINGS

FIG. 1 is a side elevational view, partly in section, of an engine and transmission drive connection interface incorporating the present invention;

FIG. 2 is a frontal elevational view of the flex plate of the present invention; and

FIG. 3 is a radially oriented sectional view taken along line 3-3 of FIG. 2.

### DESCRIPTION OF THE PREFERRED EMBODIMENT

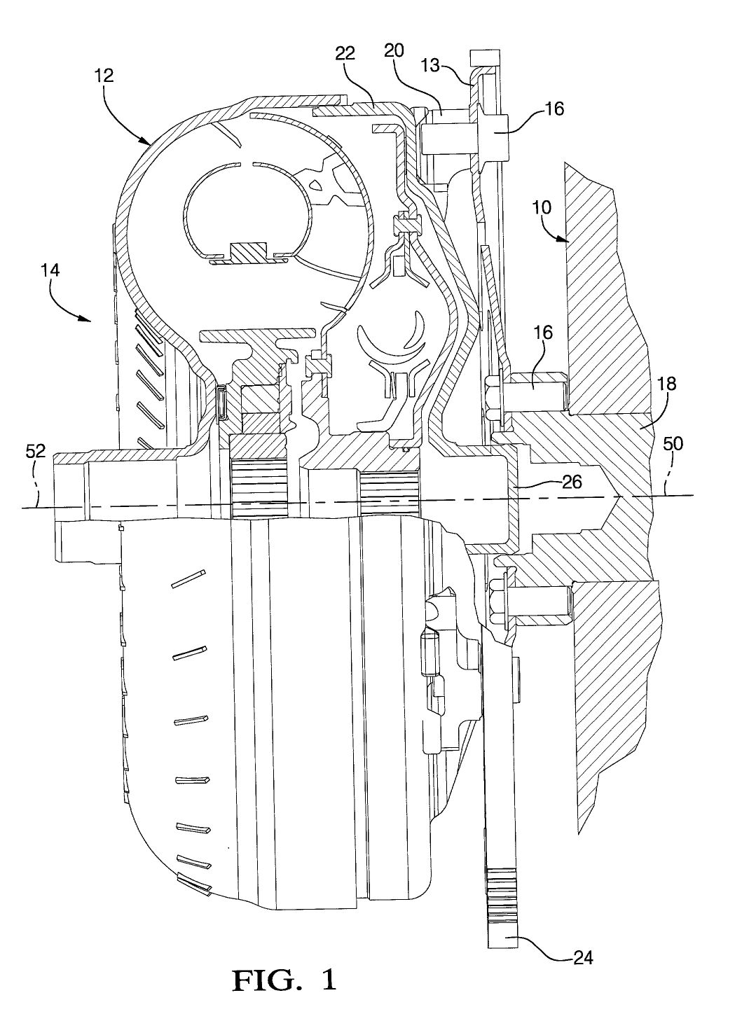

Referring to FIG. 1, a conventional engine 10, the driving component, is depicted as being drivingly connected to a conventional torque converter 12, the driven component, by a flex plate 13. The torque converter 12 is a component of a conventional transmission 14, which is well known to selectively establish a plurality of ratios between the engine 10 and a drive axle of the vehicle, not shown. The flex plate 13 is connected by threaded fasteners 16 to both the engine crankshaft 18 and lugs 20 welded to the torque converter input shell 22. Alternatively the flex plate may be connected to the engine flywheel 24 and to a flange on the torque converter. To assemble the transmission and engine, the torque converter has a nose or guide 26 which is disposed in the crankshaft 18 of the engine.

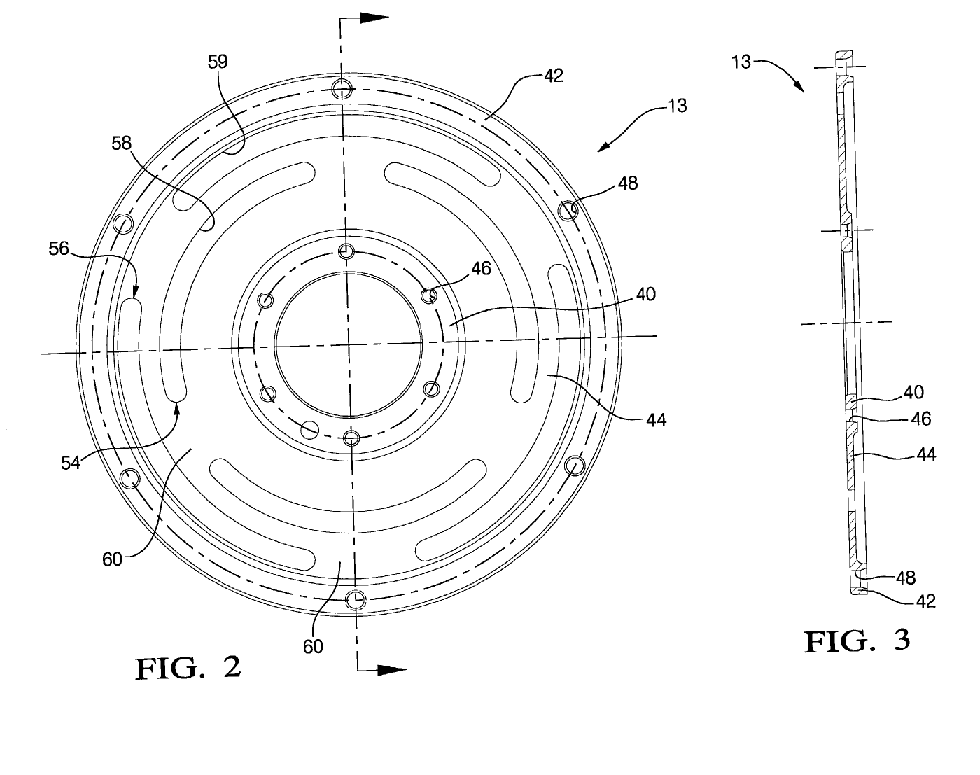

The flex plate 13 is preferably formed from a thin metal sheet, which is stamped to the configuration shown in FIGS. 2 and 3. The flex plate 13 is a substantially annular plate having an inner hub 40 near the inner periphery, an outer hub 42 about the outer periphery, and a ring portion 44 therebetween. The inner hub 40 has a plurality of equiangularly spaced openings 46 which accommodate threaded fasteners 16 for securement of the flex plate 13 to the crankshaft 18. The outer hub 42 has an equivalent number of spaced openings 48 as the inner hub 40, and the openings 48 are spaced at the same angles as the openings 46. The outer hub openings 48 accommodate threaded fasteners 16 to secure the flex plate 13 to lugs 20 welded to the torque converter input shell 22. When assembling the engine and transmission, the torque converter guide 26 and the crankshaft 18 cooperate to align the centerline 50 of the engine 10 with the centerline 52 of the torque converter 12. Generally the mounting faces of these components will be perpendicular with the centerlines 50 and 52 such that the engine and transmission are co-axially disposed. In some instances, the mounting faces may be slightly out of alignment as a result of machining tolerances, which results in slight angularity between the centerline 50 of the crankshaft and the centerline 52 of the torque converter that could result in a slight wobble of the torque converter input shell 22. To address this concern, the flex plate 13 is included to accommodate slight angular misalignment.

In order for the flex plate 13 to transfer torque from the crankshaft 18 to the torque converter 12, the flex plate must be sufficiently rigid in the circumferential direction. In contrast, to accommodate slight angular misalignment causing bending vibrations and to effectively absorb axial vibration transmitted from the engine, the flex plate must be sufficiently compliant and capable of flexing in the axial direction.

To accomplish an axially flexible and circumferentially rigid flex plate 13, the ring portion 44 of the flex plate is specifically configured. The ring portion 44 is a plate, which may or may not be flat, with one or more concentric rows of slots formed therethrough. FIG. 2 shows two rows, an inner and an outer concentric row 54 and 56 respectively, where the inner row has inner slots 58 and the outer row has outer slots 59. The inner row 54 is positioned at a smaller radius than the outer row 56. The slots 58,59 within each row are circumferential and equiangularly spaced. As compared to slots in adjacent rows, the slots are arranged in a “staggered” manner, meaning the ends of slots in adjacent rows are not located at a common angle position.

The ring portion 44 may be further described as having spokes 60 of material extending radially from an inner hub opening 46 to an outer hub opening 48 to provide radial stiffness. Due to the staggering of slots 58,59 in adjacent rows as previously described, at least one circumferential slot crosses each spoke 60. Alternate spokes 60 are interrupted alternately by an inner slot 58 and an outer slot 59. This arrangement of slots makes the flex plate 13 operate as a series of springs, much like a bellows spring. In the flex plate illustrated, there are six pairs of inner and outer hub openings 46,48 and therefore six spokes 60. As there are two concentric rows 54,56, each row includes three slots to alternatively intersect the spokes. Maintaining sufficient material in the spokes by only having one slot intersect a spoke was found to provide sufficient radial stiffness in this instance.

The thickness of the inner and outer hubs may be greater than the intermediate ring portion to support the loading from the fasteners. To reduce internal stresses at the ends of the slots, relatively large radii are specified.

The present invention provides a flex plate requiring a relatively low axial force to displace it, while producing relatively low stresses during torque transfer. The axial compliance may be tuned for the particular application by modifying the arc length of the slots and the number of rows of slots.

The foregoing description of the preferred embodiment of the invention has been presented for the purpose of illustration and description. It is not intended to be exhaustive, nor is it intended to limit the invention to the precise form disclosed. It will be apparent to those skilled in the art that the disclosed embodiment may be modified in light of the above teachings. The embodiment was chosen to provide an illustration of the principles of the invention and its practical application to thereby enable one of ordinary skill in the art to utilize the invention in various embodiments and with various modifications as are suited to the particular use contemplated. Therefore, the foregoing description is to be considered exemplary, rather than limiting, and the true scope of the invention is that described in the following claims.

1. A flex plate for transferring torque from a driving component to a driven component, comprising:
an inner hub portion secured for rotation with one of said driving component and said driven component,
an outer hub portion secured for rotation with the other one of said driving component and said driven component,
a ring portion extending from said inner hub to said outer hub where said ring portion is a plate having one or more concentric rows of slots formed therethrough, and wherein said slots are circumferential and equiangularly spaced.

2. A flex plate, as defined in claim 1, wherein said inner hub has a plurality of equiangularly spaced inner openings and said outer hub has an equivalent number of spaced outer openings and are equiangularly spaced at the same angles as said inner openings for fastening said flex plate to said driving and driven components.

3. A flex plate, as defined in claim 2, wherein said slots in adjacent concentric rows are arranged in a staggered manner.

4. A flex plate, as defined in claim 3, wherein said ring portion further comprises spokes extending radially from said inner openings to said outer openings and wherein each of said spokes is interrupted by at least one of said slots.
